(19) United States
(12) Patent Application Publication
(10) Pub. No.: US 2009/0210429 A1
(43) Pub. Date: Aug. 20, 2009

(54) System and method for asynchronous update of indexes in a distributed database

(75) Inventors: Parag Agrawal, Stanford, CA (US); Brian Cooper, San Jose, CA (US); Raghu Ramakrishnan, San Jose, CA (US); Utkarsh Srivastava, Fremont, CA (US); Ramana V. Yerneni, Cupertino, CA (US)

Correspondence Address: Law Office of Robert O. Bolan, P. O. Box 36, Bellevue, WA, 98009, US

(73) Assignee: Yahoo! Inc., Sunnyvale, CA (US)

(21) Appl. No.: 12/070,607

(22) Filed: Feb. 19, 2008

(51) Int. Cl. G06F 17/30

(52) U.S. Cl. 707/10; 707/E17.001

(57) ABSTRACT

An improved system and method for asynchronous update of indexes in a distributed database is provided. A database server may receive the request to update the data and may update the data in a primary data table of the distributed database. An asynchronous index update of the indexes may be initiated at the time a record is updated in a data table and then control may be returned to a client to perform another data update. An activity cache may be provided for caching the records updated by a client so that when the client requests a subsequent read, the updated records may be available in the activity cache to support the various guarantees for reading the data. Advantageously, the asynchronous index update scheme may provide increased performance and more scalability while efficiently maintaining indexes over database tables in a large scale, replicated, distributed database.

### FIELD OF THE INVENTION

The invention relates generally to computer systems, and more particularly to an improved system and method for asynchronous update of indexes in a distributed database.

### BACKGROUND OF THE INVENTION

Data in a database is physically organized in one sort order, but it is often useful to access the data according to a different sort order. For example, given a table of employees sorted by social security number, it is difficult to find all of the employees who live in San Jose, without scanning the whole table. The typical solution in databases is to construct an index known as a “secondary index,” which provides an alternative access path to the primary data. Thus, a data structure such as a B+ tree may be constructed which stores the employee data sorted by location, making it quite easy to locate just the San Jose employees. To access the data, the data available in the index may be sufficient, or candidate records may be retrieved from the index and used to look up records by primary key, such as social security number, in the primary table.

Indexes represent a tradeoff between performance at data update time and performance at data read time. Adding an index can improve performance for a particular read access path, but every extra index requires us to update that index when the primary data changes, incurring extra latency for the update of the primary data. These tradeoffs are even more pronounced when the database is stored in a distributed and replicated system. The distribution, which often places different partitions or copies of the database in geographically distributed locations, means that the latency penalty for waiting for indexes to be updated is increased.

Database systems usually provide transactional consistency by ensuring serializability of semantic operations on data in a distributed database. In general, each machine in a distributed database system may request and obtain locks to data records and indexes to those records while the data is updated. Once the data and the indexes are updated, the locks may be released. This approach may provide strong consistency of data in primary data tables and indexes in a replicated distributed database system. However, such a synchronous update scheme adds latency to client requests. Online applications continue to demand greater performance and higher scalability of distributed database systems upon which the online applications rely. As large-scale distributed database continue to increase in size and geographic dispersion, synchronous updates to maintain indexes concomitantly decrease performance due to the propagation delay of messages for obtaining and releasing global locks, and the need for concurrent transactions on the same data to wait for those locks to be released.

What is needed is a way to maintain indexes in a large-scale replicated and distributed database that supports scalability and performance. Such a system and method should support different guarantees for reading data from a data table so that, if a client writes a record to update data, subsequent reads should see a record which reflects the changes.

### SUMMARY OF THE INVENTION

The present invention provides a system and method for asynchronous update of indexes in a distributed database. A distributed and replicated index from data in a distributed and replicated data table may be asynchronously updated. In an embodiment, the database servers may be configured into clusters of servers with the data tables and indexes replicated in each cluster. To ensure consistency, the distributed database system may also feature a data mastering scheme. In an embodiment, one copy of the data may be designated as the master, and all updates are applied at the master before being replicated to other copies. The primary data tables may include the master records which may be assigned to a particular cluster and replicated data tables may be stored in the remaining clusters. Indexes constructed for the data tables may also be replicated and stored in each cluster. An asynchronous index update of the indexes may be initiated at the time a record is updated in a primary data table and then control may be returned to a client to perform another data update. Such an asynchronous index scheme may support different guarantees for reading data from a table, including “read any (possibly stale) version”, “read the most up to date version”, “read any version that includes a particular client's updates”, and “read any version as long as it is no older than the last version read”.

A client may accordingly invoke a query interface for sending a request to update data in a distributed database, and the request may then be sent by the query interface to a database server for processing. A database server may receive the request to update the data and may update the data in a primary data table of the distributed database. Updates to a primary table may be published to a messaging system that asynchronously propagates those updates to other replicas of the primary data table. An indication that the update of data was successful may then be sent to the client in response to the request to update the data. An asynchronous update of the indexes may be initiated for the updated data and a client may send a request to read or update data in a distributed database before the indexes to the data are asynchronously updated in response to the previous request to update the data.

Advantageously, the asynchronous index update scheme may reduce the latency before control may be returned to an application to request further query processing to be performed. Also, the total throughput of the system may be increased, since asynchronous updates can be processed in the background by otherwise idle processors. Moreover, the asynchronous index update scheme may include an activity cache for caching the records updated by a client so that when the client requests a subsequent read, the updated records may be available in the activity cache to support the various guarantees for reading the data. An application may send a database query request, for instance to read data, to a database server. The query request may be processed to obtain query results, and the activity cache for the client may be checked for any update to the requested data in the query results. The query results may be updated to reflect any updates to data in the activity cache, and the database server may send the updated query results to the client.

Thus, the present invention may provide an asynchronous update of indexes in a distributed database that may support different guarantees for reading data from a data table. Importantly, the present invention provides increased performance and more scalability while efficiently maintaining indexes over database tables in a large scale, replicated, distributed database. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for asynchronous update of indexes in a distributed database, in accordance with an aspect of the present invention;

FIG. 3 is a flowchart generally representing the steps undertaken in one embodiment for asynchronous update of indexes in a distributed database, in accordance with an aspect of the present invention;

FIG. 4 is a flowchart generally representing the steps undertaken in one embodiment for an asynchronous update of the indexes, in accordance with an aspect of the present invention; and

FIG. 5 is a flowchart generally representing the steps undertaken in one embodiment for query processing during an asynchronous update of the indexes on a database server, in accordance with an aspect of the present invention.

### DETAILED DESCRIPTION

### Exemplary Operating Environment

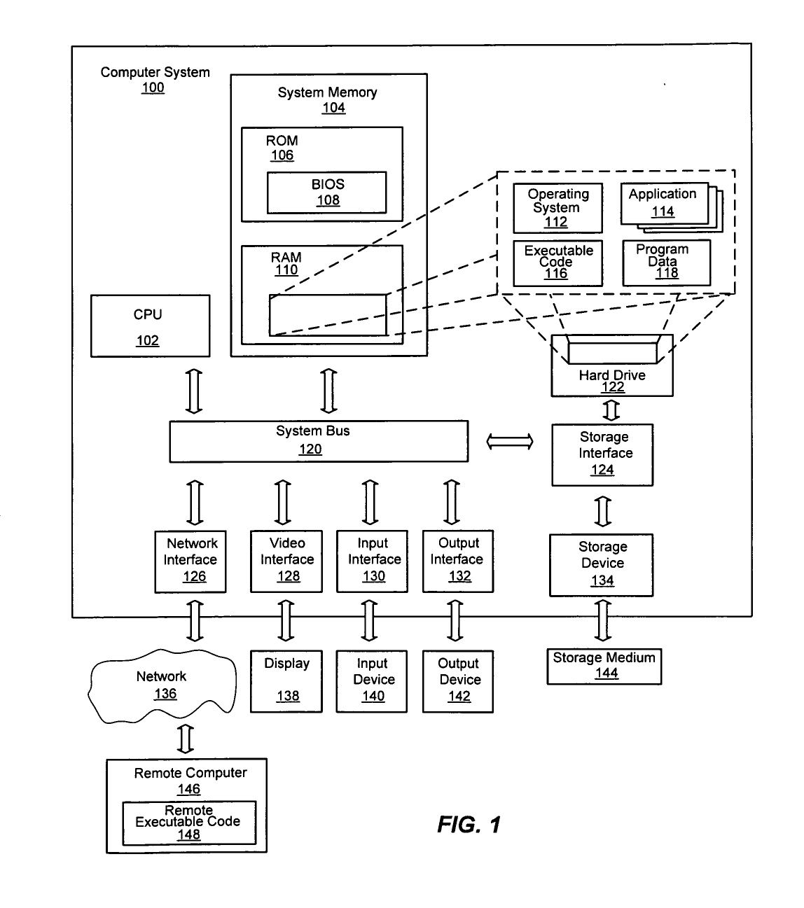

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Asynchronous Update of Indexes in a Distributed Database

The present invention is generally directed towards a system and method for asynchronous update of indexes in a distributed database. A distributed and replicated index from data in a distributed and replicated data table may be asynchronously updated. In an embodiment, the database servers may be configured into clusters of servers with the data tables and indexes replicated in each cluster. To ensure consistency, the distributed database system may also feature a data mastering scheme. In an embodiment, one copy of the data may be designated as the master, and all updates are applied at the master before being replicated to other copies. The primary data tables may include the master records which may be assigned to a particular cluster and replicated data tables may be stored in the remaining clusters. Indexes constructed for the data tables may also be replicated and stored in each cluster. An asynchronous index update of the indexes may be initiated at the time a record is updated in a primary data table and then control may be returned to a client to perform another data update.

As will be seen, such an asynchronous index scheme may support different guarantees for reading data from a table, including “read any (possibly stale) version”, “read the most up to date version”, “read any version that includes a particular client's updates”, and “read any version as long as it is no older than the last version read”. As will be understood, the various block diagrams, flow charts and scenarios described herein are only examples, and there are many other scenarios to which the present invention will apply.

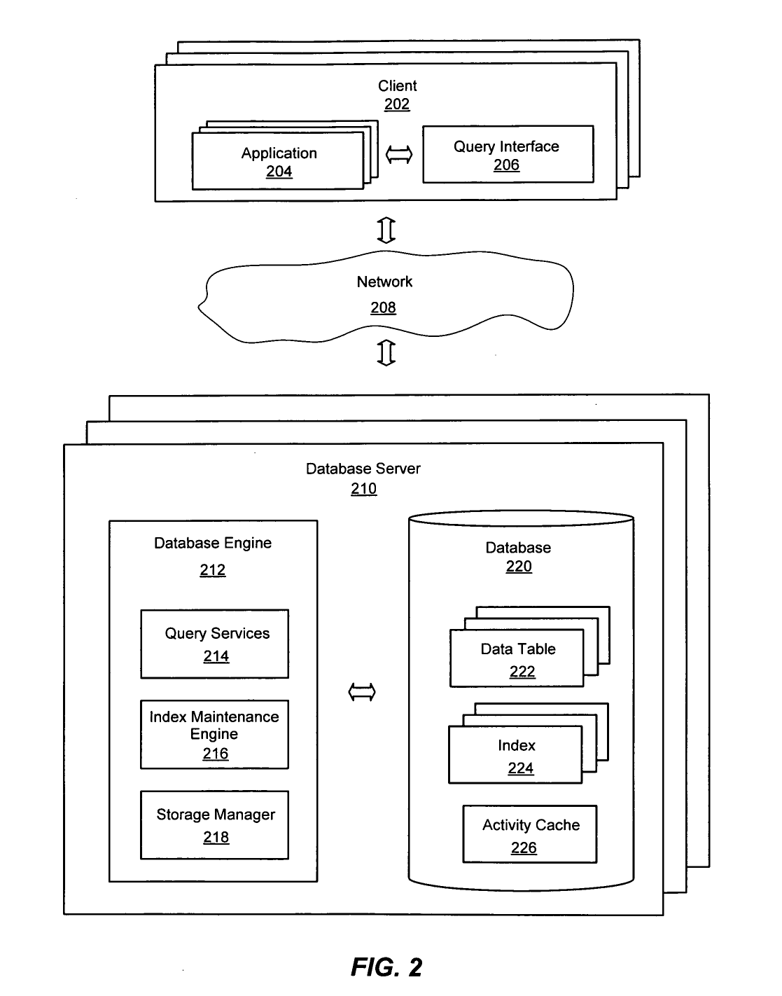

Turning to FIG. 2 of the drawings, there is shown a block diagram generally representing an exemplary architecture of system components for asynchronous update of indexes in a distributed database. Those skilled in the art will appreciate that the functionality implemented within the blocks illustrated in the diagram may be implemented as separate components or the functionality of several or all of the blocks may be implemented within a single component. For example, the functionality for the storage manager 218 on the database server 210 may be implemented as a separate component from the database engine 212. Or the functionality for the storage manager 218 may be included in the same component as the database engine 212 as shown. Moreover, those skilled in the art will appreciate that the functionality implemented within the blocks illustrated in the diagram may be executed on a single computer or distributed across a plurality of computers for execution.

In various embodiments, several networked client computers 202 may be operably coupled to one or more database servers 210 by a network 208. Each client computer 202 may be a computer such as computer system 100 of FIG. 1. The network 208 may be any type of network such as a local area network (LAN), a wide area network (WAN), or other type of network. An application 204 may execute on the client 202 and may include functionality for invoking a query interface 206 for sending a database query to a database server 210 for processing the database query. The application 204 may invoke the query interface 206 for updating data in a data table 222 of a distributed database. In general, the application 204 and the query interface 206 may be any type of interpreted or executable software code such as a kernel component, an application program, a script, a linked library, an object with methods, and so forth.

The database servers 210 may be any type of computer system or computing device such as computer system 100 of FIG. 1. The database servers 210 may represent a large distributed database system of operably coupled database servers. In general, each database server 210 may provide services for performing semantic operations on data in the database 220 and may use lower-level file system services in carrying out these semantic operations. Each database server 210 may include a database engine 212 which may be responsible for communicating with a client 202, communicating with the database servers 210 to satisfy client requests, accessing the database 220, and processing database queries. The database engine 212 may include query services 214 for processing received queries including updates of data to activity cache 226 and to the data tables 222 in the database 220, an index maintenance engine 216 for updating indexes 224 to data in the database 220, and a storage manager 218.for reading data from the database 220 and writing data to the database 220. Each of these modules may also be any type of executable software code such as a kernel component, an application program, a linked library, an object with methods, or other type of executable software code.

There are many applications which may use the present invention for asynchronous maintenance of indexes for a large distributed database. Data mining and online applications are examples among these many applications. In an embodiment, the database servers may be configured into clusters of servers with the data tables and indexes replicated in each cluster. In a clustered configuration, the database is partitioned across multiple servers so that different records are stored on different servers. Moreover, the database may be replicated so that an entire data table is copied to multiple clusters. This replication enhances both performance by having a nearby copy of the table to reduce latency for database clients and reliability by having multiple copies to provide fault tolerance.

To ensure consistency, the distributed database system may also feature a data mastering scheme. In an embodiment, one copy of the data may be designated as the master, and all updates are applied at the master before being replicated to other copies. In various embodiments, the granularity of mastership could be for a table, a partition of a table, or a record. For example, mastership of a partition of a table may be used when data is inserted or deleted, and once a record exists, record-level mastership may be used to synchronize updates to the record. The mastership scheme sequences all insert, update, and delete events on a record into a single, consistent history for the record. This history may be consistent for each replica.

A mastership scheme may allow different guarantees for reading data from a table. An application can accept “read any” which means that any, possibly out-of-date, version of a record is an acceptable result. Thus a nearby but slightly stale replica of the record is acceptable. An application can request “read-up-to-date”, which means that the most up-to-date copy of the record, available at the record master replica, must be used. Another possible guarantee is “critical read,” which is stronger than “read any” but weaker than “read-up-to-date.” In critical read, a client who has previously written a record must see a version that is at least as new as the version produced by the client's write. Accordingly, if a client writes a record, subsequent reads should see a record which reflects the changes. A fourth possible guarantee is “read forward,” which is again stronger than “read any” and weaker than “read-up-to-date.” If a client reads a record, and then reads the same record again, under the read-forward guarantee the second version read should be no older than the first version read. In other words, readers always perceive records moving forward in time, or possibly standing still, but not moving backwards.

In an embodiment, one copy of the data may be designated as the master, and all updates are applied at the master before being replicated to other copies. The primary data tables may include the master records which may be assigned to a particular cluster and replicated data tables may be stored in the remaining clusters. Indexes constructed for the data tables may also be replicated and stored in each cluster. An asynchronous index update scheme may be employed by the present invention as an alternative to a synchronous scheme, in which an asynchronous update of the indexes may be initiated at the time the primary table is updated, before returning to the user. Such an asynchronous index scheme may support different guarantees for reading data from a table, including “read any”, “read-up-to-date”, “critical read”, and “read forward”. Those skilled in the art will appreciate that in various embodiment, master records of the primary data table may be assigned to different clusters for different partitions or records, if mastership is at partition or record granularity.

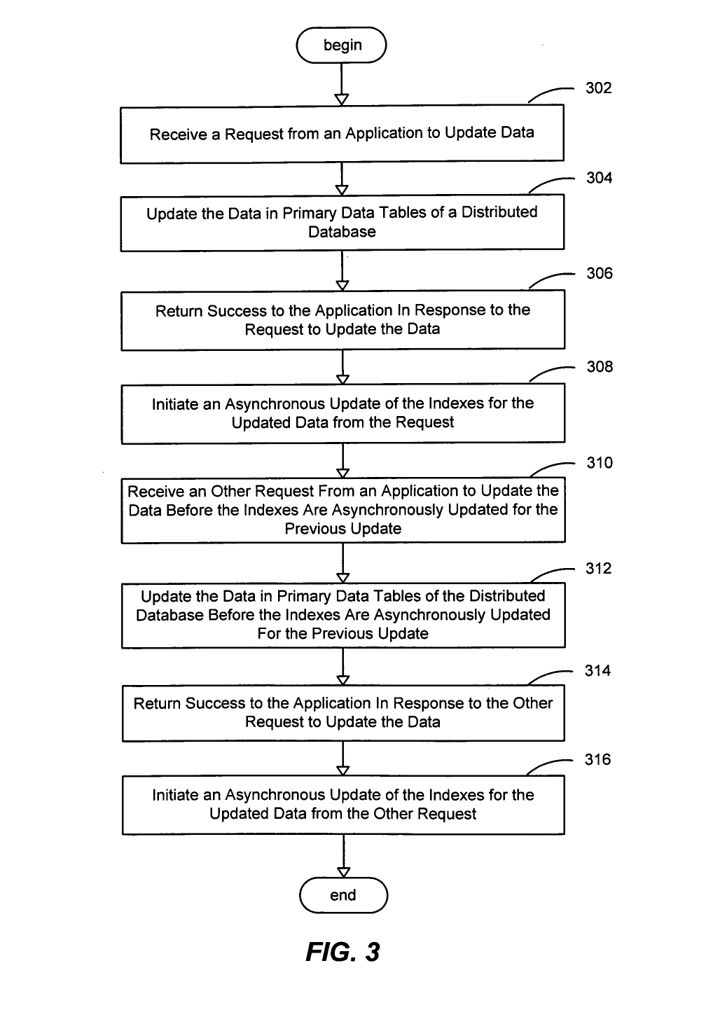

FIG. 3 presents a flowchart for generally representing the steps undertaken in one embodiment for asynchronous update of indexes in a distributed database. At step 302, a request may be received from an application to update data in a distributed database. For example, an application may invoke a query interface for sending a request to update data in a distributed database and the request may then be sent by the query interface to a database server for processing.

At step 304, the data may be updated in primary data tables of a distributed database. In an embodiment, a database server may receive the request to update the data and may update the data in primary data tables in its cluster or may forward the request to update the data to a database server in a cluster where the primary data table resides for the master record. In an embodiment, updates to the primary table at one replica may be published to a messaging system that asynchronously propagates those updates to other replicas of the primary table. In various embodiments, the update to data may be cached in an activity cache for the client. At step 306, an indication that the update of data was successful may then be sent to the application in response to the request to update the data.

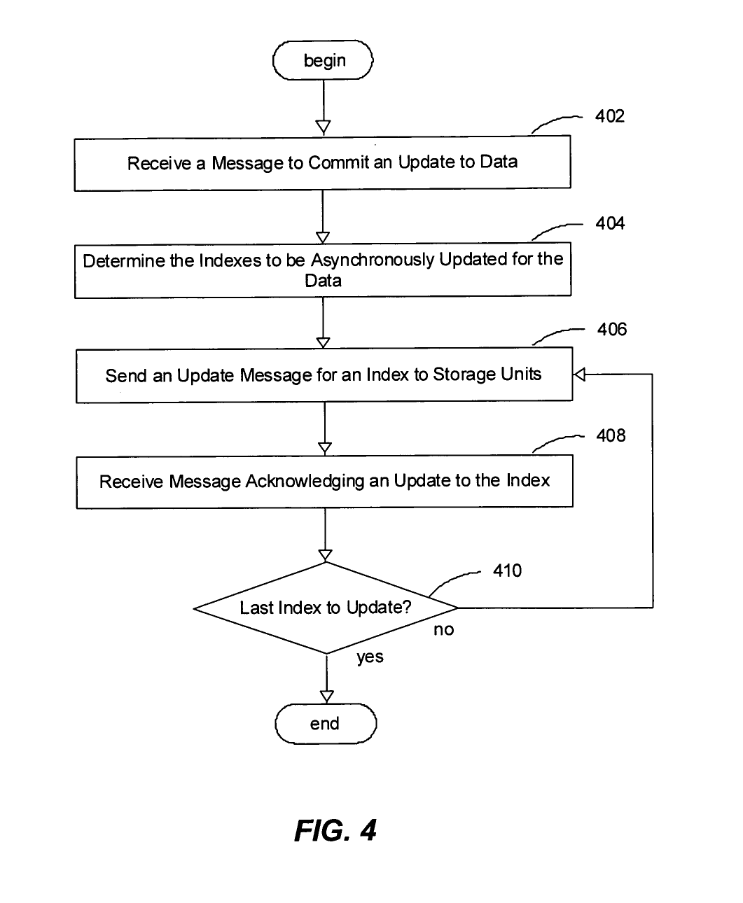

Once an indication that the update of data was successful may then be sent to the application, an asynchronous update of the indexes may be initiated at step 308 for the updated data. The steps for performing an asynchronous update of the indexes are described in detail in conjunction with FIG. 4 below. While the asynchronous update of the indexes may lazily proceed for the updated data, another request may be received at step 310 from an application to update the data before the indexes are asynchronously updated from the previous update to the data. At step 312, the data may be updated in primary data tables of the distributed database before the indexes are asynchronously updated from the previous update to the data. An indication that the update of data was successful may then be sent at step 314 to the application in response to the request to update the data, and an asynchronous update of the indexes may be initiated at step 316 for the updated data.

In an embodiment for performing an asynchronous update of the indexes, an index maintenance engine may listen to the update stream published for the primary table and generate operations which will bring the index up to date with respect to the primary table based on the received updates. For example, consider an index on employee location. If “Brian” moves from Atlanta to San Jose, the primary table will be updated to change his location. The index maintenance engine will listen to this update, and take the following actions: delete the “Atlanta, Brian” entry from the index, and insert the “San Jose, Brian” entry into the index. Because the index maintenance engine may listen to an existing stream of updates between primary table replicas, maintaining the index asynchronously adds no latency to the update of the primary table. However, because of the need to delete the old entry and insert the new entry, the update published from the primary table must include both the old version of the primary record and the new version.

Considering that the index may be treated like a regular primary table for the purposes of replication and consistency, updates to one copy of the index may be asynchronously replicated to other copies by publishing an update stream in the same way that the primary table is replicated. Similarly, the index entries may follow the same sort of mastership protocol as the primary table. Accordingly, updates to the index may be sent through a single master index.

Although the asynchronous index update scheme described above in conjunction with FIG. 3 advantageously reduces the latency incurred by a traditional synchronous index update scheme, it has the effect of allowing the index to diverge temporarily from the primary table, and this divergence may be visible to applications. Thus, an implementation of the asynchronous index update scheme should also support different guarantees for reading data from a table, including a critical read. To this end, the asynchronous index update scheme may include an activity cache for caching the records updated by a user so that when the user does a subsequent read, the updated records may be available in the activity cache to support the various guarantees for reading the data.

FIG. 4 presents a flowchart for generally representing the steps undertaken in one embodiment for an asynchronous update of the indexes. At step 402, a message may be received to commit an update to data. In an embodiment, the index maintenance engine may listen to a published stream of updates to a primary data table and receive the message to commit an update to data. At step 404, the indexes to be asynchronously updated for the update to the data may be determined. Once the indexes to be asynchronously updated may be determined, each index may be individually updated in an embodiment until all the indexes are updated. At step 406, a message to update an index may be sent to a storage unit and a message may be received at step 408 acknowledging an update to the index. At step 410, it may be determined whether the last index was updated. If not, then processing may continue at step 406 and a message to update an index may be sent to a storage unit. Otherwise, processing is finished for an asynchronous update of the indexes.

Without the implementation of the activity cache, the indexes may be out-of-date with respect to the primary table for a period of time during asynchronous update of the indexes. An update to the primary table will be immediately visible to clients, but it may be several hundred milliseconds or more before the update may appear in the indexes. This may cause a situation where clients reading the data may see different data based on whether the clients may read the data from the primary table or the index. Consider for example a client that made an update of Brian's record from “Atlanta” to “San Jose”. If that client does a read of the index before the completion of an asynchronous update of the index, the client will still see Brian as living in Atlanta. Similarly, if the client reads Brian's record from the primary table, and then from the index, the read from the index may go backward in time, violating the read-forward guarantee that the second version read should be no older than the first version read. Without the availability of an activity cache, the same query issued by a client for data updated by the client might return different results depending on whether the primary table or the secondary index was used.

To support the various guarantees for reading the data, the asynchronous index update scheme may thus include an activity cache for caching the records updated by a user so that when the user does a subsequent read, the updated records may be available in the activity cache. In an embodiment, the cache may be organized to permit fast retrieval by user. When a client may make a request to read data from the database specifying “critical read,” the data may be read from both the index and the activity cache. If a record that would match the client's query is in the activity cache but not the index, the record may be included in the query result, ensuring that the client “sees its own updates” to satisfy the critical read guarantee. If a record exists both in the index and in the activity cache, and both the index version and the cached version would match the client's query, the most recent version may be returned. In an embodiment the most recent version may be identifiable by a per-primary-record sequence number that is stored in the primary table, in the activity cache copy of the record, and also in the index entry for the record.

In various embodiments, an activity cache could also be used to provide a “read forward” guarantee. The records read by a user could be cached in an activity cache, and when the client requests a subsequent read specifying “read forward,” the version of the record in the activity cache may be returned if it is more recent than the version retrieved from the index. Thus the activity cache may be used to update query results to support various guarantees for reading the data. Note that providing a critical read requires storing records written by a client in the activity cache, while providing read forward requires storing records read by a client in the activity cache.

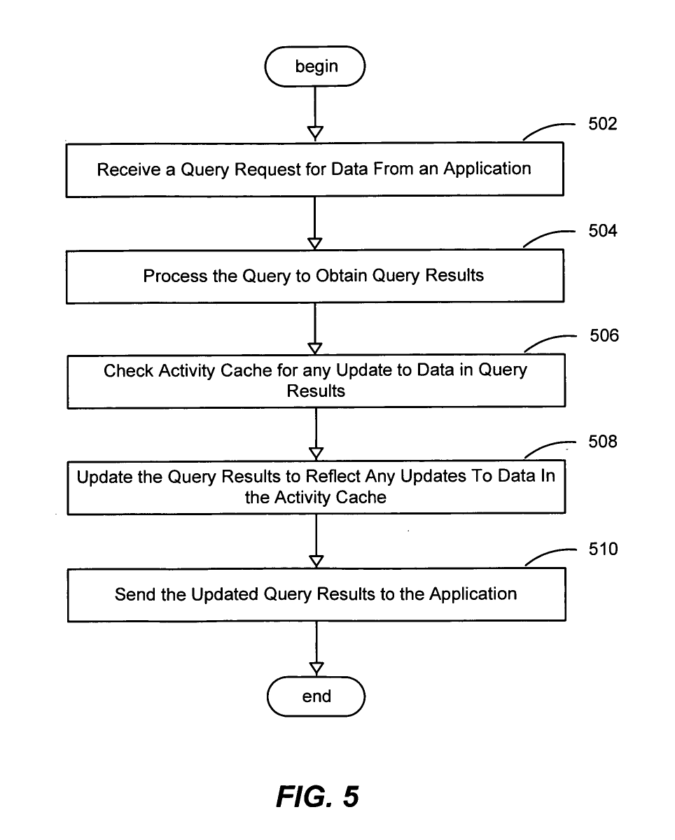

FIG. 5 presents a flowchart for generally representing the steps undertaken in one embodiment for query processing during an asynchronous update of the indexes on a database server. At step 502, a database query request may be received from an application, and the query request may be processed at step 504 to obtain query results. At step 506, the activity cache for the client may be checked for any update to data in the query results. At step 508, the query results may be updated to reflect any updates to data in the activity cache, and the database server may send the updated query results at step 510 to the application.

In various embodiments of an activity cache, records may be removed from the activity cache when they are no longer needed; otherwise, the cache will grow to contain the whole database, which is expensive and unnecessary. When the version of a record in the index is at least as new as the version in the cache, the record may be purged from the cache in an embodiment. However, it might be expensive to compute which records can be purged. In another embodiment, an expiration time may be set for records in the cache. The expiration time may be set long enough so that the index will almost certainly have caught up by the time the cache record expires. For example, if indexes usually catch up within a few hundred milliseconds of the primary update, and almost always within a second or two, setting the expiration time to be one hour will allow more than enough time. In various other embodiments, the query processor can determine, at step 506, that query results retrieved from the index are at least as new as corresponding records in the activity cache, and purge the records from the activity cache. In yet other embodiments, the index maintenance engine 216 can purge records from the activity cache after it has received acknowledgement of the update to the index in step 410.

In an embodiment, there may be multiple index maintenance engines, such as one per table replica. For a given update to the primary data table, index updates may be generated by each of the index maintenance engines. For example, consider a record “Brian” with three copies, one on the US east coast, one on the US west coast, and one in Europe. Imagine that the master copy of the “Brian” record is on the US east coast. When the “Brian” record is updated, updates may be generated by an index maintenance engine in a server cluster for the east coast, an index maintenance engine in a server cluster for west coast, and an index maintenance engine in a server cluster for Europe. However, a mechanism for “idempotence” may be used so that a given index update may be applied to the index only once and further repetitions of the same update may be ignored.

In an embodiment, an idempotence mechanism may implement the following method so that a given index update may be applied to the index only once: delete the old entry to be updated and then insert a new entry representing the updated record. Note that an index entry may not be modified in place. Thus, if an update to an index has been performed, the delete or the insert may be detected. In the case where the index entry has been deleted but an insertion of the new entry has not yet occurred, the index entry may be replaced by a tombstone that records the secondary attribute value, the primary key value and the primary record sequence number. Then, if an index maintenance engine tries to re-apply the update to the index or tries to apply an update again after the index entry has been deleted but before an insertion of the new entry has occurred, the deletion will be detected since the tombstone appears in the index. This idempotence mechanism may require a tombstone garbage collector to purge old tombstones; otherwise the index would grow without bound with tombstones. In an embodiment, the garbage collector can examine each of the copies of the index to determine when each index maintenance engine has finished an index update for the same data update. Or the tombstones may be set to expire in another embodiment after some suitable amount of time, such as a day.

Those skilled in the art will appreciate that an insert may be performed before a deletion of an existing record in an embodiment. In this case, there might be a period in which multiple index entries for the primary table record exist, even though there is only one primary table record. For such situations, the index entries may be verified using the primary table record. Furthermore, if greater consistency may be desired, the mastership consistency protocol may be used on the index table. By not checking the primary table record on inserts, roundtrip latency otherwise incurred to the primary table record from the index maintenance engine may be saved. The saving of this roundtrip latency would be significant if the primary table record was in a different region, such as the US east coast, from the index maintenance engine located on the US west coast that may be performing the insert. However, this means that the index maintenance engine must ensure that updates to the index may be properly sequenced so that the index updates may not be applied out of order.

It is also possible that the indexes may be updated before the primary data table may be updated. Consider for example an update initiated to a primary data table on the US east coast. The index maintenance engine located on the US east coast may generate updates to the index table, which may be published and received by an index maintenance engine on the US west coast before the primary table update may be received to update the replica of the primary data table on the US west coast. Then, the index located on the US west coast will be more up to date than the replica of the primary data table located on the US west coast.

For some applications this may be acceptable. However, for other applications, it may be a problem. Consider for example an application that runs a query which first looks in the index and then looks in the primary table to get more information about a record it found in the index. If the primary data table record is behind the index record, this join of the secondary index and primary data table may fail. In this case, the index record may be omitted from the query result. Alternatively, a backup copy of the index may be kept which is maintained using a checkpoint mechanism. The checkpoint mechanism may ensure that the backup copy of the index is behind the primary table. Using the backup copy of the index may solve the above problem. The backup copy may also be useful as another copy to recover from in case of a failure.

Those skilled in the art will appreciate that there may alternatively be a single index maintenance engine in an embodiment rather than multiple index maintenance engines. By using a single index maintenance engine to update replicas of indexes, there is no need to have a mechanism for idempotence. However, an implementation of a single index maintenance engine is vulnerable to failures, since the system will have to figure out what index maintenance work had not yet been done, choose a new index maintainer, and have that new index maintainer finish the work whenever the index maintainer fails.

Thus the present invention may provide asynchronous maintenance of indexes and an activity cache that may support the various guarantees for reading the data during an asynchronous update of the data. Importantly, the present invention provides increased performance and more scalability while efficiently maintaining indexes over database tables in a large scale, replicated, distributed database. By deploying multiple index maintenance engines, one for each data table replica, the system and method may achieve a high degree of fault tolerance. Moreover, by using an idempotence mechanism and a mastership consistency protocol, a high degree of consistency may be achieved for the database indexes.

As can be seen from the foregoing detailed description, the present invention provides an improved system and method for asynchronous update of indexes in a distributed database. A client may invoke a query interface for sending a request to update data in a distributed database, and the request may then be sent by the query interface to a database server for processing. A database server may receive the request to update the data and may update the data in a primary data table of the distributed database. Updates to a primary table may be published to a messaging system that asynchronously propagates those updates to other replicas of the primary data table. An indication that the update of data was successful may then be sent to the client in response to the request to update the data. An asynchronous update of the indexes may be initiated for the updated data and a client may send a request to update data in a distributed database before the indexes to the data are asynchronously updated in response to the previous request to update the data. Advantageously, the asynchronous index update scheme may reduce the latency before control may be returned to an application to request further query processing to be performed. As a result, the system and method provide significant advantages and benefits needed in contemporary computing, and more particularly in large scale online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A distributed computer system for maintaining indexes of data tables, comprising:
a plurality of database servers operably coupled to provide a distributed database stored across the plurality of database servers;
an index maintenance engine operably coupled to at least one of the plurality of database servers for asynchronously updating a plurality of indexes to data in the distributed database; and
query services operably coupled to at least one of the plurality of database servers for performing an online update to the data while the plurality of indexes to the data are asynchronously updated in the distributed database.

2. The system of claim 1 further comprising a plurality of client computers operably coupled to the plurality of database servers for sending online requests to update data stored in the distributed database while the plurality of indexes to the data are asynchronously updated in the distributed database.

3. The system of claim 1 further comprising a storage manager operably coupled to the at least one database server for updating the data in an activity cache while the plurality of indexes to the data are asynchronously updated in the distributed database.

4. A computer-readable medium having computer-executable components comprising the system of claim 1.

5. A computer-implemented method for maintaining indexes of data tables, comprising:
initiating a first asynchronous update of a plurality of indexes to data updated online in a distributed database in response to a first request to update the data online;
receiving a second request to update the data online in the distributed database before the plurality of indexes to the data are asynchronously updated in response to the first request to update the data online;
updating the data in the distributed database in response to the second request to update the data online before the plurality of indexes to the data are asynchronously updated in response to the first request to update the data online; and
initiating a second asynchronous update of the plurality of indexes to data updated online in a distributed database in response to the second request to update the data online.

6. The method of claim 5 further comprising receiving a first request to update the data online in the distributed database.

7. The method of claim 5 further comprising updating the data online in the distributed database in response to the first request to update the data online in the distributed database.

8. The method of claim 6 further comprising returning an indication of success to an application in response to the first request to update the data online in the distributed database before initiating the first asynchronous update of the plurality of indexes to data updated online in the distributed database in response to the first request to update the data online.

9. The method of claim 5 further comprising returning an indication of success to an application in response to the second request to update the data online in the distributed database before initiating the second asynchronous update of the plurality of indexes to data updated online in the distributed database in response to the second request to update the data online.

10. The method of claim 5 further comprising asynchronous updating the plurality of indexes to data updated online in a distributed database in response to the first request to update the data online.

11. The method of claim 5 further comprising receiving a message to commit the update to data.

12. The method of claim 7 further comprising caching the update to data in an activity cache.

13. The method of claim 12 further comprising determining the plurality of indexes to be updated for the data.

14. The method of claim 13 further comprising sending an update message for an index to at least one storage unit for updating the index.

15. The method of claim 12 further comprising:
receiving a query request for the data from an application;
processing the query request to obtain query results;
checking the activity cache for any updates to data in the query results; and
updating the query results to reflect any updates to data in the activity cache.

16. The method of claim 15 further comprising sending the updated query results to the application.

17. A computer-readable medium having computer-executable instructions for performing the method of claim 5.

18. A distributed computer system for maintaining indexes of data tables, comprising:
means for receiving a first request from an application to update data in a distributed database;
means for asynchronously updating a plurality of indexes to the data updated in the distributed database in response to the first request to update the data; and
means for receiving a second request from an application to perform an operation on the data in the distributed database before the plurality of indexes to the data are asynchronously updated in response to the first request to update the data.

19. The computer system of claim 18 wherein means for receiving a second request from an application to perform an operation on the data in the distributed database before the plurality of indexes to the data are asynchronously updated in response to the first request to update the data comprises:
means for receiving a second request to update the data in the distributed database before the plurality of indexes to the data are asynchronously updated in response to the first request to update the data; and
means for updating the data in the distributed database in response to the second request to update the data before the plurality of indexes to the data are asynchronously updated in response to the first request to update the data.

20. The computer system of claim 18 wherein means for receiving a second request from an application to perform an operation on the data in the distributed database before the plurality of indexes to the data are asynchronously updated in response to the first request to update the data comprises:
means for receiving a query receiving a query request for the data from the application;
means for updating the query results to reflect any updates to data; and
means for sending the updated query results to the application.
